(19) United States
(12) Patent Application Publication
(10) Pub. No.: US 2025/0102399 A1
(43) Pub. Date: Mar. 27, 2025

(54) GEARBOX FAULT DETECTION METHOD AND DEVICE

(71) Applicant: Jiangsu XCMG State Key Laboratory Technology Co., Ltd., Xuzhou (CN)

(72) Inventors: Leilei GAO, Xuzhou (CN); Junshou SU, Xuzhou (CN); Chao ZHUANG, Xuzhou (CN); Faguang LI, Xuzhou (CN)

(73) Assignee: Jiangsu XCMG State Key Laboratory Technology Co., Ltd., Xuzhou (CN)

(21) Appl. No.: 18/294,699

(22) PCT Filed: Jan. 6, 2023
(86) PCT No.: PCT/CN2023/070921

§ 371 Date: Feb. 2, 2024

(30) Foreign Application Priority Data
Dec. 27, 2022 (CN) 202211683771.6

(51) Int. Cl. G01M 13/028; G01H 13/00; G01M 13/021

(52) U.S. Cl. CPC G01M 13/028; G01H 13/00; G01M 13/021

(57) ABSTRACT

The present disclosure relates to a gearbox fault detection method and device, and relates to the technical field of fault detection. The detection method includes the following steps: acquiring a plurality of IMF components of a vibration acceleration signal of a gearbox, wherein different IMF components correspond to different parts of the gearbox; in the frequency spectrum of the IMF component, extracting frequency components corresponding to faults of different components as fault frequencies, and extracting frequency components corresponding to different components as related frequencies; and determining the fault type of the gearbox according to the fault frequency and the related frequency.

### CROSS-REFERENCE TO RELATED APPLICATIONS

The present disclosure is based on and claims priority of Chinese application for invention 202211683771.6, filed on Dec. 27, 2022, the disclosure of which is hereby incorporated into this disclosure by reference in its entirety.

### TECHNICAL FIELD

The present disclosure relates to the technical field of fault detection, in particular to a gearbox fault detection method, a gearbox fault detection device and a non-transitory computer-readable storage medium.

### BACKGROUND

As important equipment for engineering construction, construction machinery has been widely used, especially in low-speed and heavy-load situations. The working conditions of construction machinery are complex and variable. In order to adapt to various working conditions, the construction machinery's gearbox usually has a plurality of forward gears and a plurality of reverse gears. In order to adapt to different power outputs, the gearbox of construction machinery usually adopts an arrangement combining fixed shaft gears and planetary gears.

Due to the complex structure of the gearbox which is usually composed of a plurality of sets of shafts, bearings and gears, there are many types of faults, and the fault of any component can affect the safe operation of the entire device. When the construction machinery is shut down due to a fault, it will cause great economic losses. Therefore, it is important for customers' safe and efficient production to know the operation status of gearbox components in real time and predict the fault types of gears, bearings and other components in advance.

In related arts, gearbox faults are detected by vibration test and analysis.

### SUMMARY

According to some embodiments of the present disclosure, there is provided a gearbox fault detection method, comprising: acquiring plurality of IMF (Intrinsic Mode Function) components of a vibration acceleration signal of a gearbox, different IMF components corresponding to different parts of the gearbox; from spectrum of the plurality of IMF components, extracting frequency components corresponding to faults of different parts as fault frequencies, and frequency components corresponding to the different parts as relevant frequencies; determining a fault type of the gearbox according to the fault frequencies and the relevant frequencies.

In some embodiments, determining a fault type of the gearbox comprises: determining the fault type of the gearbox according to a combined harmonic frequency of the fault frequencies and the relevant frequencies, wherein the combined harmonic frequency is determined according to a harmonic frequency of a fault frequency and a harmonic frequency of a relevant frequency.

In some embodiments, determining a fault type of the gearbox comprises: determining a fault type of the gearbox according to an amplitude ratio of a sum of amplitude values of a combined harmonic frequency to a sum of amplitude values of a relevant frequency.

In some embodiments, the different parts comprise a fixed shaft gear; the relevant frequency corresponding to the fixed shaft gear comprises a gear mesh frequency; the fault of the fixed shaft gear comprises at least one of a fixed shaft driving gear fault or a fixed shaft driven gear fault, the fault frequency corresponding to the fixed shaft driving gear fault comprises a driving gear fault frequency, and the fault frequency corresponding to the fixed shaft driven gear fault comprises a driven gear fault frequency.

In some embodiments, in a case that the greatest common divisor (GCD) between the numbers of teeth of a pair of fixed shaft gears that mesh with each other is not 1, for the fixed shaft driven gear fault, the relevant frequency corresponding to the fixed shaft gear further comprises a gear assembly phase frequency.

In some embodiments, the different parts comprise a fixed shaft bearing; the relevant frequency corresponding to the fixed shaft bearing comprises a gearbox natural frequency; the fault of the fixed shaft bearing comprises at least one of a fixed shaft bearing outer ring fault, a fixed shaft bearing inner ring fault or a fixed shaft bearing rolling element fault; the fault frequency corresponding to the fixed shaft bearing outer ring fault comprises a bearing outer ring fault frequency, the fault frequency corresponding to the fixed shaft bearing inner ring fault frequency comprises a fixed shaft bearing inner ring fault frequency, and the fault frequency corresponding to the fixed shaft bearing rolling element fault comprises a bearing rolling element fault frequency.

In some embodiments, the different parts comprise a planetary gear train (PGT); the relevant frequency corresponding to the PGT comprises a gear mesh frequency; the fault of the PGT comprises at least one of a sun gear fault, a planet gear fault or a gear ring fault; for the sun gear fault, the relevant frequency corresponding to the PGT further comprises an absolute rotation frequency of the sun gear, and the fault frequency corresponding to the PGT comprises a fault frequency of the sun gear; for the planet gear fault, the relevant frequency corresponding to the PGT further comprises a planet carrier rotation frequency, and the fault frequency corresponding to the PGT comprises a planet gear fault frequency; for the gear ring fault, the fault frequency corresponding to the PGT comprises a gear ring fault frequency.

In some embodiments, the different parts comprise a planet gear bearing; the relevant frequency corresponding to the planet gear bearing comprises a gearbox natural frequency and a planet carrier rotation frequency; the fault of the planet gear bearing comprises at least one of a planet gear bearing outer ring fault, a planet gear bearing inner ring fault, or a planet gear bearing rolling element fault; for the planet gear bearing outer ring fault, the relevant frequency corresponding to the planet gear bearing further comprises a bearing outer ring rotation frequency, and the fault frequency corresponding to the planet gear bearing comprises a bearing outer ring fault frequency; for the planet gear bearing inner ring fault, the fault frequency corresponding to the planet gear bearing comprises a bearing inner ring fault frequency; for the planet gear bearing rolling element fault, the relevant frequency corresponding to the planet gear bearing further comprises a bearing cage rotation frequency, and the fault frequency corresponding to the planet gear bearing comprises a bearing rolling element fault frequency.

In some embodiments, determining a fault type of the gearbox comprises: determining a fault type of the gearbox according to comparisons of amplitude ratios corresponding to different faults and ratio thresholds, wherein different amplitude ratios correspond to different ratio thresholds.

In some embodiments, determining a fault type of the gearbox comprises: determining a current feature vector of the gearbox according to the amplitude ratios corresponding to different faults, a time domain kurtosis factor of the vibration acceleration signal, and a crest factor of the vibration acceleration signal; determining a fault type of the gearbox according to the current feature vector and a plurality of sample feature vectors corresponding to a plurality of fault types.

In some embodiments, determining a fault type of the gearbox comprises: calculating a relation degree of the current feature vector and each of the plurality of sample feature vectors respectively; sorting the relation degrees; determining the fault type of the gearbox according to a result of the sorting.

In some embodiments, acquiring plurality of IMF components of the vibration acceleration signal of the gearbox comprises: performing EMD (Empirical Mode Decomposition) or EEMD (Ensemble Empirical Mode Decomposition) on the vibration acceleration signal to obtain the plurality of IMF components.

In some embodiments, acquiring plurality of IMF components comprises: performing EMD or EEMD on the vibration acceleration signal to obtain plurality of candidate IMF components; according to relevant parameters of different parts of the gearbox, determining the plurality of IMF components from the plurality of candidate IMF components.

In some embodiments, acquiring plurality of IMF components comprises: removing a false IMF component from the plurality of candidate IMF components according to relations between the plurality of candidate IMF components and the vibration acceleration signal; determining the plurality of IMF components from the plurality of candidate IMF components after removing the false IMF component.

According to some embodiments of the present disclosure, there is provided a gearbox fault detection device, comprising: a frequency domain indicator extraction module for acquiring plurality of IMF components of a vibration acceleration signal of a gearbox, different IMF components corresponding to different parts of the gearbox; from spectrum of the plurality of IMF components, extracting frequency components corresponding to faults of different parts as fault frequencies, and frequency components corresponding to the different parts as relevant frequencies; a fault determination module for determining a fault type of the gearbox according to the fault frequencies and the relevant frequencies.

In some embodiments, the fault determination module is used for determining the fault type of the gearbox according to a combined harmonic frequency of the fault frequencies and the relevant frequencies, wherein the combined harmonic frequency is determined according to a harmonic frequency of a fault frequency and a harmonic frequency of a relevant frequency.

In some embodiments, the fault determination module is used for determining a fault type of the gearbox according to an amplitude ratio of a sum of amplitude values of a combined harmonic frequency to a sum of amplitude values of a relevant frequency.

In some embodiments, the different parts comprise a fixed shaft gear; the relevant frequency corresponding to the fixed shaft gear comprises a gear mesh frequency; the fault of the fixed shaft gear comprises at least one of a fixed shaft driving gear fault or a fixed shaft driven gear fault, the fault frequency corresponding to the fixed shaft driving gear fault comprises a driving gear fault frequency, and the fault frequency corresponding to the fixed shaft driven gear fault comprises a driven gear fault frequency.

In some embodiments, in a case that the greatest common divisor (GCD) between the numbers of teeth of a pair of fixed shaft gears that mesh with each other is not 1, for the fixed shaft driven gear fault, the relevant frequency corresponding to the fixed shaft gear further comprises a gear assembly phase frequency.

In some embodiments, the different parts comprise a fixed shaft bearing; the relevant frequency corresponding to the fixed shaft bearing comprises a gearbox natural frequency; the fault of the fixed shaft bearing comprises at least one of a fixed shaft bearing outer ring fault, a fixed shaft bearing inner ring fault or a fixed shaft bearing rolling element fault; the fault frequency corresponding to the fixed shaft bearing outer ring fault comprises a bearing outer ring fault frequency, the fault frequency corresponding to the fixed shaft bearing inner ring fault frequency comprises a fixed shaft bearing inner ring fault frequency, and the fault frequency corresponding to the fixed shaft bearing rolling element fault comprises a bearing rolling element fault frequency.

In some embodiments, the different parts comprise a planetary gear train (PGT); the relevant frequency corresponding to the PGT comprises a gear mesh frequency; the fault of the PGT comprises at least one of a sun gear fault, a planet gear fault or a gear ring fault; for the sun gear fault, the relevant frequency corresponding to the PGT further comprises an absolute rotation frequency of the sun gear, and the fault frequency corresponding to the PGT comprises a fault frequency of the sun gear; for the planet gear fault, the relevant frequency corresponding to the PGT further comprises a planet carrier rotation frequency, and the fault frequency corresponding to the PGT comprises a planet gear fault frequency; for the gear ring fault, the fault frequency corresponding to the PGT comprises a gear ring fault frequency.

In some embodiments, the different parts comprise a planet gear bearing; the relevant frequency corresponding to the planet gear bearing comprises a gearbox natural frequency and a planet carrier rotation frequency; the fault of the planet gear bearing comprises at least one of a planet gear bearing outer ring fault, a planet gear bearing inner ring fault, or a planet gear bearing rolling element fault; for the planet gear bearing outer ring fault, the relevant frequency corresponding to the planet gear bearing further comprises a bearing outer ring rotation frequency, and the fault frequency corresponding to the planet gear bearing comprises a bearing outer ring fault frequency; for the planet gear bearing inner ring fault, the fault frequency corresponding to the planet gear bearing comprises a bearing inner ring fault frequency; for the planet gear bearing rolling element fault, the relevant frequency corresponding to the planet gear bearing further comprises a bearing cage rotation frequency, and the fault frequency corresponding to the planet gear bearing comprises a bearing rolling element fault frequency.

In some embodiments, the fault determination module is used for determining a fault type of the gearbox according to comparisons of amplitude ratios corresponding to different faults and ratio thresholds, wherein different amplitude ratios correspond to different ratio thresholds.

In some embodiments, the fault determination module is used for determining a current feature vector of the gearbox according to the amplitude ratios corresponding to different faults, a time domain kurtosis factor of the vibration acceleration signal, and a crest factor of the vibration acceleration signal; determining a fault type of the gearbox according to the current feature vector and a plurality of sample feature vectors corresponding to a plurality of fault types.

In some embodiments, the fault determination module is used for calculating a relation degree of the current feature vector and each of the plurality of sample feature vectors, respectively; sorting the relation degrees; determining the fault type of the gearbox according to a result of the sorting.

In some embodiments, the frequency domain indicator extraction module is used for performing EMD or EEMD on the vibration acceleration signal to obtain the plurality of IMF components.

In some embodiments, the frequency domain indicator extraction module is used for performing EMD or EEMD on the vibration acceleration signal to obtain plurality of candidate IMF components; according to relevant parameters of different parts of the gearbox, determining the plurality of IMF components from the plurality of candidate IMF components.

In some embodiments, the frequency domain indicator extraction module is used for removing a false IMF component from the plurality of candidate IMF components according to relations between the plurality of candidate IMF components and the vibration acceleration signal; determining the plurality of IMF components from the plurality of candidate IMF components after removing the false IMF component.

According to still other embodiments of the present disclosure, there is provided a gearbox fault detection device, comprising: memory; a processor coupled to the memory, the processor configured to, based on instructions stored in the memory, carry out the gearbox fault detection method according to any one of the above embodiments.

According to still other embodiments of the present disclosure, there is provided a non-transitory computer readable storage medium having stored thereon a computer program that, when executed by a processor, implements the gearbox fault detection method according to any one of the above embodiments.

### BRIEF DESCRIPTION OF THE DRAWINGS

The accompanying drawings, which are incorporated in and constitute a portion of this specification, illustrate embodiments of the present disclosure and, together with the description, serve to explain the principles of the present disclosure.

The present disclosure will be more clearly understood from the following detailed description with reference to the accompanying drawings, in which:

FIG. 1 shows the flow chart of a gearbox fault detection method according to some embodiments of the present disclosure;

FIG. 2 shows the flow chart of the gearbox fault detection method according to other embodiments of the present disclosure;

FIG. 3 shows a block diagram of a gearbox fault detection device according to some embodiments of the present disclosure;

FIG. 4 shows a block diagram of the gearbox fault detection device according to other embodiments of the present disclosure;

FIG. 5 shows a block diagram of the gearbox fault detection device according to still other embodiments of the present disclosure;

FIG. 6 shows a block diagram of a gearbox fault detection device according to further embodiments of the present disclosure.

### DETAILED DESCRIPTION

Various exemplary embodiments of the present disclosure will now be described in detail with reference to the accompanying drawings. Notice that, Unless otherwise specified, the relative arrangement, numerical expressions and numerical values of the components and steps set forth in these examples do not limit the scope of the invention.

At the same time, it should be understood that, for ease of description, the dimensions of the various parts shown in the drawings are not drawn to actual proportions.

The following description of at least one exemplary embodiment is in fact merely illustrative and is in no way intended as a limitation to the invention, its application or use.

Techniques, methods, and apparatus known to those of ordinary skill in the relevant art may not be discussed in detail, but where appropriate, these techniques, methods, and apparatuses should be considered as part of the specification.

Of all the examples shown and discussed herein, any specific value should be construed as merely illustrative and not as a limitation. Thus, other examples of exemplary embodiments may have different values.

Notice that, similar reference numerals and letters are denoted by the like in the accompanying drawings, and therefore, once an article is defined in a drawing, there is no need for further discussion in the accompanying drawings.

The inventors of the present disclosure have found the following problems existed in the related arts: the completion of the detection needs manual assistance, resulting in poor detection performance.

In view of this, the present disclosure provides a technical solution for gearbox fault detection, which can improve the detection performance.

As mentioned above, the structure of the gearbox of a construction machinery is very complex. the gearbox's internal transmission structure comprises not only fixed shaft gears and bearings, but also planetary gears and bearings. Under the comprehensive effect of the complex motion characteristics and dynamics essence of the PGT, as well as variable environmental excitation, the vibration test signal of the PGT has very apparent complexity, time-varying and modulation characteristics.

The characteristic frequencies of various parts of the gearbox are coupled with each other, as well as the interference of background noise, causing that the vibration test signal finally collected is very complex, which makes it difficult to diagnose wear, pitting, broken tooth faults of a gear and wear, pitting, fracture faults of a bearing inner ring, a bearing outer ring and a bearing rolling element.

Therefore, how to quickly and accurately process vibration test data and identify main fault characteristics, improve the efficiency and reliability of gearbox fault diagnosis, is very important to the gearbox fault diagnosis of a construction machinery.

However, in vibration test and analysis, most of the vibration test and analysis are complex and the effect is not ideal. Moreover, the vibration test and analysis still needs to be assisted by manual analysis of the vibration signal to achieve fault feature extraction. This leads to low detection efficiency, and artificial diagnosis depends on human experience. Different people may lead to different diagnosis conclusions, and thereby the reliability of diagnosis results is poor.

In view of the above technical problems, the present disclosure provides a fault diagnosis method and system for the gearbox of a construction machinery. For example, the technical solution of the present disclosure can be realized through the following embodiments.

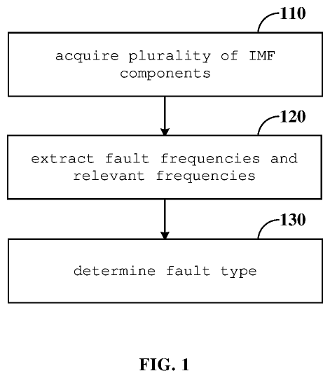

FIG. 1 shows the flow chart of a gearbox fault detection method according to some embodiments of the present disclosure.

As shown in FIG. 1, in step 110, a plurality of IMF components of a vibration acceleration signal of a gearbox are acquired, wherein different IMF components correspond to different parts of the gearbox. For example, according to some test standards, a vibration acceleration sensor can be disposed at a shell with large rigidity, for example, at the shell of the gearbox bearing seat of a construction machinery, to measure a gearbox vibration acceleration signal.

In some embodiments, EMD or EEMD is performed on the vibration acceleration signal to obtain a plurality of IMF components.

For example, EMD or EEMD is performed on the vibration acceleration signal to obtain a plurality of candidate IMF components; according to relevant parameters of different parts of the gearbox, a plurality of IMF components are determined from the plurality of candidate IMF components.

For example, false IMF components are removed from the plurality of candidate IMF components according to relations between the plurality of candidate IMF components and the vibration acceleration signal; a plurality of IMF components are determined from the plurality of candidate IMF components after removing the false IMF components.

For example, the vibration acceleration signal after noise elimination is performed EMD or EEMD to obtain a plurality of IMF components, and false IMF components are removed according to relations between the IMF components and the signal before decomposition; then, independent IMF components representing a fixed shaft gear, a fixed shaft bearing, a PGT, and a planet gear bearing are selected respectively based on the numbers of relevant gear teeth, bearing parameters, input shaft speeds at specific gears, a natural frequency of the gearbox and the like.

For example, a pre-process (such as noise elimination) can be performed on the measured vibration acceleration signal of the gearbox, and then a time domain kurtosis factor K and a crest factor C are extracted.

In step 120, from spectrum of the plurality of IMF components, frequency components corresponding to faults of different parts are extracted as fault frequencies, and frequency components corresponding to the different parts are extracted as relevant frequencies.

For example, FFT (Fast Fourier Transform) is performed on the independent IMF components obtained in step 110 that respectively represent a fixed shaft gear, a fixed shaft bearing, a PGT and a planet gear bearing; a frequency amplitude rate (i.e. amplitude ratio) of a gear fault frequency component corresponding to the fixed shaft gear, a frequency amplitude rate of a bearing element fault frequency component corresponding to the fixed shaft bearing, a frequency amplitude rate of a gear fault frequency component corresponding to the PGT, and a frequency amplitude rate of a bearing element fault frequency component corresponding to the planet gear bearing are extracted to prepare for determining a fault type of the gearbox.

In step 130, a fault type of the gearbox is determined according to the fault frequencies and the relevant frequencies.

In the above embodiment, through extracting frequency features of different IMF components corresponding to different parts in the frequency domain, a fault type of the gearbox can be determined according to the frequency features. In this way, the vibration acceleration signal can be analyzed without manual assistance, and the fault detection can be implemented automatically, thus improving the detection performance.

In some embodiments, a fault type of the gearbox can be determined according to combined harmonic frequencies of the fault frequencies and the relevant frequencies, wherein a combined harmonic frequency is determined according to a harmonic frequency of a fault frequency and a harmonic frequency of a relevant frequency.

In some embodiments, a fault type of the gearbox is determined according to an amplitude ratio of a sum of amplitude values of a combined harmonic frequency to a sum of amplitude values of a relevant frequency.

In some embodiments, the different parts comprise a fixed shaft gear; the relevant frequency corresponding to the fixed shaft gear comprises a gear mesh frequency; the fault of the fixed shaft gear comprises at least one of a fixed shaft driving gear fault or a fixed shaft driven gear fault, the fault frequency corresponding to the fixed shaft driving gear fault comprises a driving gear fault frequency, and the fault frequency corresponding to the fixed shaft driven gear fault comprises a driven gear fault frequency.

For example, in a case that the greatest common divisor (GCD) between the numbers of teeth of a pair of fixed shaft gears that mesh with each other is not 1, for the fixed shaft driven gear fault, the relevant frequency corresponding to the fixed shaft gear further comprises a gear assembly phase frequency.

In some embodiments, FFT is performed on the independent IMF component representing the fixed shaft gear to obtain a frequency spectrum of the fixed shaft gear signal; then, a frequency amplitude rate of components comprising the driving gear fault frequency component and a frequency amplitude rate of components comprising the driven gear fault frequency component are calculated, respectively.

For example, for the fixed shaft driving gear fault, the feature frequencies related to the driving gear fault in the spectrum are a combination of gear mesh frequency fₘ and driving gear fault frequency f_{ga}, and combined harmonic frequency thereof (such as j*fₘ±i*f_{ga}, wherein j*fₘ is the harmonic frequency of fₘ, and i*f_{ga} is the harmonic frequency of f_{ga}. The frequency amplitude rate (amplitude ratio) comprising the driving gear fault frequency component is the result of dividing the sum of frequency amplitude values comprising the driving gear fault frequency component by the sum of remaining frequency amplitude values of feature frequencies related to the driving gear fault after excluding the driving gear fault component.

A frequency amplitude rate A_{ga} of spectrum comprising the driving gear fault frequency component f_{ga} is calculated by the following formula:

$${A}_{ga} = {\sum }_{i = - n}^{n} {\sum }_{j = 1}^{m} A ( j * {f}_{m} + i * {f}_{g a} ) / {\sum }_{j = 1}^{m} A ( j * {f}_{m} )$$

i is the harmonic order of the driving gear fault frequency component f_{ga}, and i≠0, n is the highest harmonic order, which can be n=5; j is the harmonic order of the gear mesh frequency fₘ, and m is the highest harmonic order, which can be m=5; A(j*fₘ+i*f_{ga}) is the amplitude value corresponding to the frequency comprising the driving gear fault frequency component f_{ga} in the gear signal spectrum; A(j*fₘ) is the amplitude value corresponding to the mesh frequency fₘ in the gear signal spectrum.

For example, if the GCD Nₐ between the numbers of teeth of a pair of fixed shaft gears that mesh with each other is not 1, a gear assembly phase frequency fₐ=k*fₘ/Nₐ should also be considered. In this case, the calculation formula of A_{ga} is as follows:

$${A}_{ga} = {\sum }_{i = - n}^{n} {\sum }_{j = 1}^{m} {\sum }_{k = 1}^{{N}_{a}} A ( j * {f}_{m} + i * {f}_{ga} + k * {f}_{a} ) / {\sum }_{j = 1}^{m} {\sum }_{k = 1}^{{N}_{a}} A ( j * {f}_{m} + k * {f}_{a} )$$

i is the harmonic order of the driving gear fault frequency component f_{ga}, and i≠0, n is the highest harmonic order, which can be n=5; j is the harmonic order of the gear mesh frequency fin, and m is the highest harmonic order, which can be m=5; k is the harmonics order of the gear assembly phase frequency fₐ, and Nₐ is the GCD between the numbers of teeth of two gears that mesh with each other, which is not 1; A(j*fₘ+i*f_{ga}+k*fₐ) is the amplitude value corresponding to the frequency comprising the driving gear fault frequency component f_{ga} in the gear signal spectrum; A(j*fₘ+k*fₐ) is the amplitude value corresponding to a combination of mesh frequency fₘ and gear assembly phase frequency fₐ in the gear signal spectrum.

For example, for the fixed shaft driven gear fault, the feature frequencies related to the driven gear fault in the spectrum are a combination of gear mesh frequency fin, driven gear fault frequency f_{gp}, and combined harmonic frequency thereof, which can be represented as j*fₘ±i*f_{gp}. A frequency amplitude rate comprising the driven gear fault frequency component is defined as an result of the sum of amplitude values comprising the driven gear fault frequency component dividing the sum of amplitude values of remaining frequency after excluding the driven gear fault frequency component from all the feature frequencies related to the fault of the driven gear.

A frequency amplitude rate A_{gp} of spectrum comprising the driven gear fault frequency component f_{gp} is calculated by the following formula:

$${A}_{gp} = {\sum }_{i = - n}^{n} {\sum }_{j = 1}^{m} A ( j * {f}_{m} + i * {f}_{gp} ) / {\sum }_{j = 1}^{m} A ( j * {f}_{m} )$$

i is the harmonic order of the driven gear fault frequency component f_{ga}, and i≠0; n is the highest harmonic order, which can be n=5; j is the harmonic order of the gear mesh frequency fₘ, and m is the highest harmonic order, which can be m=5; A(j*fₘ+i*f_{gp}) is the amplitude value corresponding to the frequency comprising the driven gear fault frequency component f_{gp} in the gear signal spectrum; A(j*fₘ) is the amplitude value corresponding to the mesh frequency fₘ in the gear signal spectrum.

For example, if the GCD Nₐ between the numbers of teeth of a pair of fixed shaft gears that mesh with each other is not 1, a gear assembly phase frequency fₐ=k*fₘ/Nₐ should also be considered. In this case, the calculation formula of A_{gp} is as follows:

$${A}_{gp} = {\sum }_{i = - n}^{n} {\sum }_{j = 1}^{m} {\sum }_{k = 1}^{{N}_{a}} A ( j * {f}_{m} + i * {f}_{gp} + k * {f}_{a} ) / {\sum }_{j = 1}^{m} {\sum }_{k = 1}^{{N}_{a}} A ( j * {f}_{m} + k * {f}_{a} )$$

i is the harmonic order of the driven gear fault frequency component f_{gp}, and i≠0; n is the highest harmonic order, which can be n=5; j is the harmonic order of the gear mesh frequency fₘ, and m is the highest harmonic order, which can be m=5; k is the harmonics order of the gear assembly phase frequency fₐ, and Nₐ is the GCD between the numbers of teeth of two gears that mesh with each other, which is not 1; A(j*fₘ+i*f_{gp}+k*fₐ) is the amplitude value corresponding to the frequency comprising the driven gear fault frequency component f_{gp} in the gear signal spectrum; A(j*fₘ+k*fₐ) is the amplitude value corresponding to a combination of mesh frequency fₘ and gear assembly phase frequency fₐ in the gear signal spectrum.

In some embodiments, the different parts comprise a fixed shaft bearing; the relevant frequency corresponding to the fixed shaft bearing comprises a gearbox natural frequency; the fault of the fixed shaft bearing comprises at least one of a fixed shaft bearing outer ring fault, a fixed shaft bearing inner ring fault or a fixed shaft bearing rolling element fault; the fault frequency corresponding to the fixed shaft bearing outer ring fault comprises a bearing outer ring fault frequency, the fault frequency corresponding to the fixed shaft bearing inner ring fault frequency comprises a fixed shaft bearing inner ring fault frequency, and the fault frequency corresponding to the fixed shaft bearing rolling element fault comprises a bearing rolling element fault frequency.

In some embodiments, FFT is performed on the independent IMF component representing the fixed shaft bearing to obtain a frequency spectrum of the fixed shaft bearing signal; then, a frequency amplitude rate of components comprising the bearing outer ring fault frequency component, a frequency amplitude rate of components comprising the bearing inner ring fault frequency component, and a frequency amplitude rate of components comprising the bearing rolling element fault frequency component are calculated from the spectrum, respectively.

For example, for the fixed shaft bearing outer ring fault, the feature frequencies related to the bearing outer ring fault in the spectrum are a combination of gearbox natural frequency fₙ and bearing outer ring fault frequency f_{Bo}, and combined harmonic frequency thereof, which can be represented as j*fₙ±i*f_{Bo}. A frequency amplitude rate of components comprising the bearing outer ring fault frequency component is defined as an amplitude ratio of the sum of amplitude values of components comprising the bearing outer ring fault frequency component to the sum of amplitude values of remaining components after excluding the components comprising the bearing outer ring fault frequency component from all the feature frequencies related to the fault of the bearing outer ring.

A frequency amplitude rate A_{Bo} of components comprising the bearing outer ring fault frequency component f_{Bo} is calculated by the following formula:

$${A}_{Bo} = {\sum }_{i = - n}^{n} {\sum }_{j = 1}^{m} A ( j * {f}_{n} + i * {f}_{Bo} ) / {\sum }_{j = 1}^{m} A ( j * {f}_{n} )$$

i is the harmonic order of the bearing outer ring fault frequency component f_{Bo}, and i≠0; n is the highest harmonic order, which can be n=5; j is the harmonic order of the gearbox natural frequency fₙ, and m is the highest harmonic order, which can be m=5; A(j*fₙ+i*f_{Bo}) is the amplitude value corresponding to the frequency comprising the bearing outer ring fault frequency component f_{Bo} in the bearing signal spectrum; A(j*fₙ) is the amplitude value corresponding to the gearbox natural frequency fₙ in the bearing signal spectrum.

For example, for the fixed shaft bearing inner ring fault, the feature frequencies related to the bearing inner ring fault in the spectrum are a combination of gearbox natural frequency fₙ and bearing inner ring fault frequency f_{Bi}, and combined harmonic frequency thereof, which can be represented as j*fₙ±i*f_{Bi}. A frequency amplitude rate of components comprising the bearing inner ring fault frequency component is defined as an amplitude ratio of the sum of amplitude values of components comprising the bearing inner ring fault frequency component to the sum of amplitude values of remaining components after excluding the components comprising the bearing inner ring fault frequency component from all the feature frequencies related to the fault of the bearing inner ring.

A frequency amplitude rate A_{Bi} of components comprising the bearing inner ring fault frequency component f_{Bi} is calculated by the following formula:

$${A}_{Bi} = {\sum }_{i = - n}^{n} {\sum }_{j = 1}^{m} A ( j * {f}_{n} + i * {f}_{Bi} ) / {\sum }_{j = 1}^{m} A ( j * {f}_{n} )$$

i is the harmonic order of the bearing inner ring fault frequency component f_{Bi}, and i≠0; n is the highest harmonic order, which can be n=5; j is the harmonic order of the gearbox natural frequency fₙ, and m is the highest harmonic order, which can be m=5; A(j*fₙ+i*f_{Bi}) is the amplitude value corresponding to the frequency comprising the bearing inner ring fault frequency component f_{Bi} in the bearing signal spectrum; A(j*fₙ) is the amplitude value corresponding to the gearbox natural frequency fₙ in the bearing signal spectrum.

For example, for the fixed shaft bearing rolling element fault, the feature frequencies related to the bearing rolling element fault in the spectrum are a combination of gearbox natural frequency fₙ and bearing rolling element fault frequency f_{Bb}, and combined harmonic frequency thereof, which can be represented as j*fₙ±i*f_{Bb}. A frequency amplitude rate of components comprising the bearing rolling element fault frequency component is defined as an amplitude ratio of the sum of amplitude values of components comprising the bearing rolling element fault frequency component to the sum of amplitude values of remaining components after excluding the components comprising the bearing rolling element fault frequency component from all the feature frequencies related to the fault of the bearing rolling element.

A frequency amplitude rate A_{Bb} of components comprising the bearing rolling element fault frequency component f_{Bb} is calculated by the following formula:

$${A}_{Bb} = {\sum }_{i = - n}^{n} {\sum }_{i = 1}^{m} A ( j * {f}_{n} + i * {f}_{Bb} ) / {\sum }_{i = 1}^{m} A ( j * {f}_{n} )$$

i is the harmonic order of the bearing rolling element fault frequency component f_{Bb}, and i≠0; n is the highest harmonic order, which can be n=5; j is the harmonic order of the gearbox natural frequency fₙ, and m is the highest harmonic order, which can be m=5; A(j*fₙ+i*f_{Bb}) is the amplitude value corresponding to the frequency comprising the bearing rolling element fault frequency component f_{Bb} in the bearing signal spectrum; A(j*fₙ) is the amplitude value corresponding to the gearbox natural frequency fₙ in the bearing signal spectrum.

In some embodiments, the different parts comprise a planetary gear train (PGT); the relevant frequency corresponding to the PGT comprises a gear mesh frequency; the fault of the PGT comprises at least one of a sun gear fault, a planet gear fault or a gear ring fault; for the sun gear fault, the relevant frequency corresponding to the PGT further comprises an absolute rotation frequency of the sun gear, and the fault frequency corresponding to the PGT comprises a fault frequency of the sun gear; for the planet gear fault, the relevant frequency corresponding to the PGT further comprises a planet carrier rotation frequency, and the fault frequency corresponding to the PGT comprises a planet gear fault frequency; for the gear ring fault, the fault frequency corresponding to the PGT comprises a gear ring fault frequency.

In some embodiments, FFT is performed on the independent IMF component representing the PGT to obtain a frequency spectrum of the PGT; then, a frequency amplitude rate of components comprising the sun gear fault frequency component, a frequency amplitude rate of components comprising the planet gear fault frequency component, and a frequency amplitude rate of components comprising the gear ring fault frequency component are calculated from the spectrum, respectively, specifically for a PGT with a sun gear input, a planet carrier output and a fixed gear ring.

For example, for the sun gear fault, the feature frequencies related to the sun gear fault in the spectrum are a combination of gear mesh frequency fₘ, sun gear fault frequency fₛ, sun gear absolute rotation frequency fₛ^{(r)}, and combined harmonic frequency thereof, which can be represented as j*fₘ±i*fₛ±k*fₛ^{(r)}). A frequency amplitude rate of components comprising the sun gear fault frequency component is defined as an amplitude ratio of the sum of amplitude values of components comprising the sun gear fault frequency component to the sum of amplitude values of remaining components after excluding the components comprising the sun gear fault frequency component from all the feature frequencies related to the fault of the sun gear.

A frequency amplitude rate Aₚₛ of components comprising the sun gear fault frequency component fₛ is calculated by the following formula:

$${A}_{ps} = {\sum }_{i = - n}^{n} {\sum }_{j = 1}^{m} {\sum }_{k = - l}^{l} A ( j * {f}_{m} + i * {f}_{s} + k * {f}_{s}^{( r )} ) / {\sum }_{j = 1}^{m} {\sum }_{k = - l}^{l} A ( j * {f}_{m} + k * {f}_{s}^{( r )} )$$

i is the harmonic order of the sun gear fault frequency component fₛ, and i≠0; n is the highest harmonic order, which can be n=5; j is the harmonic order of the planet gear mesh frequency fₘ, and m is the highest harmonic order, which can be m=5; k is the harmonic order of the sun gear absolute rotation frequency fₛ^{(r)} and k is the highest harmonic order, which can be k=5; A(j*fₘ+i*fₛ+k*fₛ^{(r)}) is the amplitude value corresponding to the frequency comprising the sun gear fault frequency component fₛ in the gear signal spectrum; A(j*fₘ+k*f r) is the amplitude value corresponding to a combination of mesh frequency fₘ and sun gear absolute rotation frequency fₛ^{(r)} in the gear signal spectrum.

For example, for the planet gear fault, the feature frequencies related to the planet gear fault in the spectrum are a combination of gear mesh frequency fₘ, planet gear fault frequency fₚ, planet carrier rotation frequency f_{c}, and combined harmonic frequency thereof, which can be represented as j*fₘ±i*fₚ±k*f_{c}. A frequency amplitude rate of components comprising the planet gear fault frequency component is defined as an amplitude ratio of the sum of amplitude values of components comprising the planet gear fault frequency component to the sum of amplitude values of remaining components after excluding the components comprising the planet gear fault frequency component from all the feature frequencies related to the fault of the planet gear.

A frequency amplitude rate Aₚₚ of components comprising the planet gear fault frequency component fₚ is calculated by the following formula:

$${A}_{pp} = {\sum }_{i = - n}^{n} {\sum }_{j = 1}^{m} {\sum }_{k = - l}^{l} A ( j * {f}_{m} + i * {f}_{p} + k * {f}_{c} ) / {\sum }_{j = 1}^{m} {\sum }_{k = - l}^{l} A ( j * {f}_{m} + k * {f}_{c} )$$

i is the harmonic order of the planet gear fault frequency component fₚ, and i≠0; n is the highest harmonic order, which can be n=5; j is the harmonic order of the planet gear mesh frequency fin, and m is the highest harmonic order, which can be m=5; k is the harmonic order of the planet carrier rotation frequency f_{c}, and I is the highest harmonic order, which can be l=5; A(j*fₘ+i*fₛ+k*f_{c}) is the amplitude value corresponding to the frequency comprising the sun gear fault frequency component fₛ in the gear signal spectrum; A(j*fₘ+k*f_{c}) is the amplitude value corresponding to a combination of mesh frequency fₘ and planet carrier rotation frequency f_{c} in the gear signal spectrum.

For example, for the gear ring fault, the feature frequencies related to the gear ring fault in the spectrum are a combination of gear mesh frequency fₘ, gear ring fault frequency fᵣ, and combined harmonic frequency thereof, which can be represented as j*fₘ±i*fᵣ. A frequency amplitude rate of components comprising the gear ring fault frequency component is defined as an amplitude ratio of the sum of amplitude values of components comprising the gear ring fault frequency component to the sum of amplitude values of remaining components after excluding the components comprising the gear ring fault frequency component from all the feature frequencies related to the fault of the gear ring.

A frequency amplitude rate Aₚᵣ of components comprising the gear ring fault frequency component fᵣ is calculated by the following formula:

$${A}_{pr} = {\sum }_{i = - n}^{n} {\sum }_{j = 1}^{m} A ( j * {f}_{m} + i * {f}_{r} ) / {\sum }_{j = 1}^{m} A ( j * {f}_{m} )$$

i is the harmonic order of the gear ring fault frequency component fᵣ, and i≠0; n is the highest harmonic order, which can be n=5; j is the harmonic order of the gear mesh frequency fₘ, and m is the highest harmonic order, which can be m=5; A(j*fₘ+i*fᵣ) is the amplitude value corresponding to the frequency comprising the gear ring fault frequency component fᵣ in the gear signal spectrum; A(j*fₘ) is the amplitude value corresponding to the mesh frequency fₘ in the gear signal spectrum.

In some embodiments, the different parts comprise a planet gear bearing; the relevant frequency corresponding to the planet gear bearing comprises a gearbox natural frequency and a planet carrier rotation frequency; the fault of the planet gear bearing comprises at least one of a planet gear bearing outer ring fault, a planet gear bearing inner ring fault, or a planet gear bearing rolling element fault; for the planet gear bearing outer ring fault, the relevant frequency corresponding to the planet gear bearing further comprises a bearing outer ring rotation frequency, and the fault frequency corresponding to the planet gear bearing comprises a bearing outer ring fault frequency; for the planet gear bearing inner ring fault, the fault frequency corresponding to the planet gear bearing comprises a bearing inner ring fault frequency; for the planet gear bearing rolling element fault, the relevant frequency corresponding to the planet gear bearing further comprises a bearing cage rotation frequency, and the fault frequency corresponding to the planet gear bearing comprises a bearing rolling element fault frequency.

In some embodiments, FFT is performed on the independent IMF component representing the planet gear bearing to obtain a frequency spectrum of the planet gear bearing; then, a frequency amplitude rate of components comprising the planet gear bearing outer ring fault frequency component, a frequency amplitude rate of components comprising the planet gear bearing inner ring fault frequency component, and a frequency amplitude rate of components comprising planet gear bearing rolling element fault frequency component are calculated from the spectrum, respectively, specifically for a PGT with a sun gear input, a planet carrier output and a fixed gear ring.

For example, for the planet gear bearing outer ring fault, the feature frequencies related to the bearing outer ring fault in the spectrum are a combination of gearbox natural frequency fₙ, bearing outer ring fault frequency fₒ, planet carrier rotation frequency f_{c}, bearing outer ring rotation frequency f(s) and combined harmonic frequency thereof, which can be represented as j*fₙ±i*fₒ±k*f_{c}±p*fₒ^{(s)}. A frequency amplitude rate of components comprising the bearing outer ring fault frequency component is defined as an amplitude ratio of the sum of amplitude values of components comprising the bearing outer ring fault frequency component to the sum of amplitude values of remaining components after excluding the components comprising the bearing outer ring fault frequency component from all the feature frequencies related to the fault of the bearing outer ring.

A frequency amplitude rate Aₚₒ of components comprising the bearing outer ring fault frequency component fₒ is calculated by the following formula:

$${A}_{po} = {\sum }_{i = - n}^{n} {\sum }_{j = 1}^{m} {\sum }_{k = - l}^{l} {\sum }_{p = - q}^{q} A ( j * {f}_{n} + i * {f}_{o} + k * {f}_{c} + p * {f}_{o}^{( s )} ) / {\sum }_{j = 1}^{m} {\sum }_{k = - l}^{l} {\sum }_{p = - q}^{q} A ( j * {f}_{n} + k * {f}_{c} + p * {f}_{o}^{( s )} )$$

i is the harmonic order of the bearing outer ring fault frequency component fₒ, and i≠0; n is the highest harmonic order, which can be n=5; j is the harmonic order of the gearbox natural frequency fₙ, and m is the highest harmonic order, which can be m=5; k is the harmonic order of the planet carrier rotation frequency f_{c}, and l is the highest harmonic order, which can be l=5; p is the harmonic order of the bearing outer ring rotation frequency fₒ^{(s)}, and q is the highest harmonic order, which can be q=5; A(j*fₙ+i*fₒ+k*f_{c}+p*fₒ^{(s)}) is the amplitude value corresponding to the frequency comprising the bearing outer ring fault frequency component fₒ in the bearing signal spectrum; A(j*fₙ+k*f_{c}+p*fₒ^{(s)}) is the amplitude value corresponding to a combination of gearbox natural frequency fₙ, planet carrier rotation frequency f_{c}, bearing outer ring rotation frequency fₒ^{(s)} in the bearing signal spectrum.

For example, for the planet gear bearing inner ring fault, the feature frequencies related to the bearing inner ring fault in the spectrum are a combination of gearbox natural frequency fₙ, bearing inner ring fault frequency fᵢ, and planet carrier rotation frequency f_{c}, and combined harmonic frequency thereof, which can be represented as j*fₙ±i*fᵢ±k*f_{c}. A frequency amplitude rate of components comprising the bearing inner ring fault frequency component is defined as an amplitude ratio the sum of amplitude values of components comprising the bearing inner ring fault frequency component to the sum of amplitude values of remaining components after excluding the components comprising the bearing inner ring fault frequency component from all the feature frequencies related to the fault of the bearing inner ring.

A frequency amplitude rate Aₚᵢ of components comprising the bearing inner ring fault frequency component fᵢ is calculated by the following formula:

$${A}_{pi} = {\sum }_{i = - n}^{n} {\sum }_{j = 1}^{m} {\sum }_{k = - l}^{l} A ( j * {f}_{n} + i * {f}_{i} + k * {f}_{c} ) / {\sum }_{j = 1}^{m} {\sum }_{k = - l}^{l} A ( j * {f}_{n} + k * {f}_{c} )$$

i is the harmonic order of the bearing inner ring fault frequency component fᵢ, and i≠0; n is the highest harmonic order, which can be n=5; j is the harmonic order of the gearbox natural frequency fₙ, and m is the highest harmonic order, which can be m=5; k is the harmonic order of the planet carrier rotation frequency f_{c}, and l is the highest harmonic order, which can be l=5; A(j*fₙ+i*fᵢ+k*f_{c}) is the amplitude value corresponding to the frequency comprising the bearing inner ring fault frequency component fi in the bearing signal spectrum; A(j*fₙ+k*f_{c}) is the amplitude value corresponding to a combination of gearbox natural frequency fₙ and planet carrier rotation frequency f_{c} in the gear signal spectrum.

For example, for the planet gear bearing rolling element fault, the feature frequencies related to the bearing rolling element fault in the spectrum are a combination of gearbox natural frequency fₙ and bearing rolling element fault frequency f_{b}, planet carrier rotation frequency f_{c}, bearing cage rotation frequency f_{cg}, and combined harmonic frequency thereof, which can be represented as j*fₙ±i*f_{b}±k*f_{c}±p*f_{cg}. A frequency amplitude rate of components comprising the bearing rolling element fault frequency component is defined as an amplitude ratio of the sum of amplitude values of components comprising the bearing rolling element fault frequency component to the sum of amplitude values of remaining components after excluding the components comprising the bearing rolling element fault frequency component from all the feature frequencies related to the fault of the bearing rolling element.

A frequency amplitude rate A_{pb} of components comprising the bearing rolling element fault frequency component f_{b} is calculated by the following formula:

$${A}_{p b} = {\sum }_{i = - n}^{n} {\sum }_{j = 1}^{m} {\sum }_{k = - l}^{l} {\sum }_{p = - q}^{q} A ( j * {f}_{n} + i * {f}_{b} + k * {f}_{c} + p * {f}_{cg} ) / {\sum }_{j = 1}^{m} {\sum }_{k = - l}^{l} {\sum }_{p = - q}^{q} A ( j * {f}_{n} + k * {f}_{c} + p * {f}_{cg} )$$

i is the harmonic order of the bearing rolling element fault frequency component f_{b}, and i≠0; n is the highest harmonic order, which can be n=5; j is the harmonic order of the gearbox natural frequency fₙ, and m is the highest harmonic order, which can be m=5; k is the harmonic order of the planet carrier rotation frequency f_{c}, and l is the highest harmonic order, which can be l=5; p is the harmonic order of the bearing cage rotation frequency f_{cg}, and q is the highest harmonic order, which can be q=5; A(j*fₙ+i*f_{b}+k*f_{c}+p*f_{cg}) is the amplitude value corresponding to the frequency comprising the bearing rolling element fault frequency f_{b} in the bearing signal spectrum; A(j*fₙ+k*f_{c}+p*ffy) is the amplitude value corresponding to a combination of gearbox natural frequency fₙ, planet carrier rotation frequency f_{c}, bearing cage rotation frequency f_{cg} in the bearing signal spectrum.

In some embodiments, a fault type of the gearbox is determined according to a comparison of amplitude ratios corresponding to different faults and ratio thresholds, different amplitude ratios correspond to different ratio thresholds.

In some embodiments, the time domain kurtosis factor K and crest factor C calculated in step 110, the frequency amplitude rate of the gear fault frequency component, the frequency amplitude rate of the bearing element fault frequency component, the frequency amplitude rate of the gear fault frequency component and the frequency amplitude rate of the bearing element fault frequency component calculated in step 130 are compared with their respective thresholds to determine the fault type of the gearbox.

In some embodiments, the calculated time domain kurtosis factor K, crest factor C, the frequency amplitude rate of components comprising the driving gear fault frequency component, the frequency amplitude rate of components comprising the driven gear fault frequency component are compared with their respective thresholds to determine the type of fixed shaft gear fault.

For example, for a fixed shaft driving gear fault, the frequency amplitude rate A_{ga} of components comprising the driving gear fault frequency component f_{ga} is calculated; if K is greater than threshold K_{I} and A_{ga} is greater than threshold A_{ga I}, it can be determined that the driving gear has a broken tooth fault; if K is less than or equal to threshold K_{I} and greater than threshold K_{II}, A_{ga} is less than or equal to threshold A_{ga I} and greater than threshold A_{ga II}, it can be determined that the driving gear has a pitting fault; if K is less than or equal to threshold K_{II}, C is greater than threshold C_{I}, A_{ga} is less than or equal to threshold A_{ga II} and greater than threshold A_{gaIII}, it can be determined that the driving gear has a wear fault; if K is less than or equal to threshold K_{II}, C is less than or equal to threshold C_{I}, A_{ga} is less than or equal to threshold A_{gaIII} it can be determined that the driving gear has no fault.

For example, for a fixed shaft driven gear fault, the frequency amplitude rate A_{gp} of components comprising the driven gear fault frequency component f_{gp} is calculated; if K is greater than threshold K_{I} and A_{gp} is greater than threshold A_{gp I}, it can be determined that the driven gear has a broken tooth fault; if K is less than or equal to threshold K_{I} and greater than threshold K_{II}, A_{gp} is less than or equal to threshold A_{gp I} and greater than threshold A_{gp II} it can be determined that the driven gear has a pitting fault; if K is less than or equal to threshold K_{II}, C is greater than threshold C_{I}, A_{gp} is less than or equal to threshold A_{gp II} and greater than threshold A_{gpIII} it can be determined that the driven gear has a wear fault; if K is less than or equal to threshold K_{II}, C is less than or equal to threshold C_{I}, A_{gp} is less than or equal to threshold A_{gpIII}, it can be determined that the driven gear has no fault.

In some embodiments, the calculated frequency amplitude rate of components comprising the bearing outer ring fault frequency component, the frequency amplitude rate of components comprising the bearing inner ring fault frequency component, and the frequency amplitude rate of components comprising the bearing rolling element fault frequency component are compared with their respective thresholds to determine the type of fixed shaft bearing element fault.

For example, for a fixed shaft bearing outer ring fault, the frequency amplitude rate A_{Bo} of components comprising the bearing outer ring fault frequency component f_{Bo} is calculated; if K is greater than threshold K_{I} and A_{Bo} is greater than threshold A_{Bo I}, it can be determined that the bearing outer ring has a broken fault; if K is less than or equal to threshold K_{I} and greater than threshold K_{II}, A_{Bo} is less than or equal to threshold A_{Bo I} and greater than threshold A_{Bo II}, it can be determined that the bearing outer ring has a pitting fault; if K is less than or equal to threshold K_{II}, C is greater than threshold C_{I}, A_{Bo} is less than or equal to threshold A_{Bo II} and greater than threshold A_{BoIII}, it can be determined that the bearing outer ring has a wear fault; if K is less than or equal to threshold K_{II}, C is less than or equal to threshold C_{I}, A_{Bo} is less than or equal to threshold A_{BoIII}, it can be determined that the bearing outer ring has no fault.

For example, for a fixed shaft bearing inner ring fault, the frequency amplitude rate A_{Bi} of components comprising the bearing inner ring fault frequency component f_{Bi} is calculated; if K is greater than threshold K_{I} and A_{Bi} is greater than threshold A_{Bi I}, it can be determined that the bearing inner ring has a broken fault; if K is less than or equal to threshold K_{I} and greater than threshold K_{II}, A_{Bi} is less than or equal to threshold A_{Bi I} and greater than threshold A_{Bi II}, it can be determined that the bearing inner ring has a pitting fault; if K is less than or equal to threshold K_{II}, C is greater than threshold C_{I}, A_{Bi} is less than or equal to threshold A_{Bi II} and greater than threshold A_{BiIII}, it can be determined that the bearing inner ring has a wear fault; if K is less than or equal to threshold K_{II}, C is less than or equal to threshold C_{I}, A_{Bi} is less than or equal to threshold A_{BiIII}, it can be determined that the bearing inner ring has no fault.

For example, for a fixed shaft bearing rolling element fault, the frequency amplitude rate A_{Bb} of components comprising the bearing rolling element fault frequency component f_{Bb} is calculated; if K is greater than threshold K_{I} and A_{Bb} is greater than threshold A_{Bb I}, it can be determined that the bearing rolling element has a broken fault; if K is less than or equal to threshold K_{I} and greater than threshold K_{II}, A_{Bb} is less than or equal to threshold A_{Bb II} and greater than threshold A_{BbIII}, it can be determined that the bearing rolling element has a pitting fault; if K is less than or equal to threshold K_{II}, C is greater than threshold C_{I}, A_{Bb} is less than or equal to threshold A_{Bb I} and greater than threshold A_{Bb II}, it can be determined that the bearing rolling element has a wear fault; if K is less than or equal to threshold K_{II}, C is less than or equal to threshold C_{I}, A_{Bb} is less than or equal to threshold A_{BbIII}, it can be determined that the bearing rolling element has no fault.

In some embodiments, the calculated frequency amplitude rate of components comprising the sun gear fault frequency component, the frequency amplitude rate of components comprising the planet gear fault frequency component, and the frequency amplitude rate of components comprising the gear ring fault frequency component are compared with their respective thresholds to determine the type of PGT fault.

For example, for a sun gear fault, the frequency amplitude rate Aₚₛ of components comprising the sun gear fault frequency component fₛ is calculated; if K is greater than threshold K_{I} and Aₚₛ is greater than threshold A_{ps I}, it can be determined that the sun gear has a broken tooth fault; if K is less than or equal to threshold K_{I} and greater than threshold K_{II}, Aₚₛ is less than or equal to threshold A_{ps I} and greater than threshold A_{ps II}, it can be determined that the sun gear has a pitting fault; if K is less than or equal to threshold K_{II}, C is greater than threshold C_{I}, Aₚₛ is less than or equal to threshold A_{ps II} and greater than threshold A_{psIII}, it can be determined that the sun gear has a wear fault; if K is less than or equal to threshold K_{II}, C is less than or equal to threshold C_{I}, Aps is less than or equal to threshold A_{psIII}, it can be determined that the sun gear has no fault.

For example, for a planet gear fault, the frequency amplitude rate Aₚₚ of components comprising the planet gear fault frequency component fₚ is calculated; if K is greater than threshold K_{I} and Aₚₚ is greater than threshold A_{pp I}, it can be determined that the planet gear has a broken tooth fault; if K is less than or equal to threshold K_{I} and greater than threshold K_{II}, App is less than or equal to threshold A_{pp I} and greater than threshold A_{pp II}, it can be determined that the planet gear has a pitting fault; if K is less than or equal to threshold K_{II}, C is greater than threshold C_{I}, Aₚₚ is less than or equal to threshold A_{pp II} and greater than threshold A_{ppIII}, it can be determined that the planet gear has a wear fault; if K is less than or equal to threshold K_{II}, C is less than or equal to threshold C_{I}, Aₚₚ is less than or equal to threshold A_{ppIII}, it can be determined that the planet gear has no fault.

For example, for a gear ring fault, the frequency amplitude rate Aₚᵣ of components comprising the gear ring fault frequency component fᵣ is calculated; if K is greater than threshold K_{I} and Aₚᵣ is greater than threshold A_{pr I}, it can be determined that the gear ring has a broken tooth fault; if K is less than or equal to threshold K_{I} and greater than threshold K_{II}, Aₚᵣ is less than or equal to threshold A_{pr I} and greater than threshold A_{pr II}, it can be determined that the gear ring has a pitting fault; if K is less than or equal to threshold K_{II}, C is greater than threshold C_{I}, Aₚᵣ is less than or equal to threshold A_{pr II} and greater than threshold A_{prIII}, it can be determined that the gear ring has a wear fault; if K is less than or equal to threshold K_{II}, C is less than or equal to threshold C_{I}, Aₚᵣ is less than or equal to threshold A_{prIII}, it can be determined that the gear ring has no fault.

In some embodiments, the calculated frequency amplitude rate of components comprising the planet gear bearing outer ring fault frequency component, the frequency amplitude rate of components comprising the planet gear bearing inner ring fault frequency component, and the frequency amplitude rate of components comprising the planet gear bearing rolling element fault frequency component are compared with their respective thresholds to determine the type of planet gear bearing element fault.

For example, for a planet gear bearing outer ring fault, the frequency amplitude rate Aₚₒ of components comprising the bearing outer ring fault frequency component fₒ is calculated; if K is greater than threshold K_{I} and Aₚₒ is greater than threshold A_{po I}, it can be determined that the bearing outer ring has a broken fault; if K is less than or equal to threshold K_{I} and greater than threshold K_{II}, Aₚₒ is less than or equal to threshold A_{po I} and greater than threshold A_{po II}, it can be determined that the bearing outer ring has a pitting fault; if K is less than or equal to threshold K_{II}, C is greater than threshold C_{I}, Aₚₒ is less than or equal to threshold A_{po II} and greater than threshold A_{poIII}, it can be determined that the bearing outer ring has a wear fault; if K is less than or equal to threshold K_{I}, C is less than or equal to threshold C_{I}, Aₚₒ is less than or equal to threshold A_{poIII}, it can be determined that the bearing outer ring has no fault.

For example, for a planet gear bearing inner ring fault, the frequency amplitude rate Aₚᵢ of components comprising the bearing inner ring fault frequency component fᵢ is calculated; if K is greater than threshold K_{I} and Aₚᵢ is greater than threshold A_{pi I}, it can be determined that the bearing inner ring has a broken fault; if K is less than or equal to threshold K_{I} and greater than threshold K_{II}, Aₚᵢ is less than or equal to threshold A_{pi I}, and greater than threshold A_{pi II}, it can be determined that the bearing inner ring has a pitting fault; if K is less than or equal to threshold K_{II}, C is greater than threshold C_{I}, Aₚᵢ is less than or equal to threshold A_{pi II} and greater than threshold A_{piIII}, it can be determined that the bearing inner ring has a wear fault; if K is less than or equal to threshold K_{II}, C is less than or equal to threshold C_{I}, Aₚᵢ is less than or equal to threshold A_{piIII}, it can be determined that the bearing inner ring has no fault.

For example, for a planet gear bearing rolling element fault, the frequency amplitude rate A_{pb} of components comprising the bearing rolling element fault frequency component f_{b} is calculated; if K is greater than threshold K_{I} and A_{pb} is greater than threshold A_{pb I}, it can be determined that the bearing rolling element has a broken fault; if K is less than or equal to threshold K_{I} and greater than threshold K_{II}, A_{pb} is less than or equal to threshold A_{pb I} and greater than threshold A_{pb II}, it can be determined that the bearing rolling element has a pitting fault; if K is less than or equal to threshold K_{II}, C is greater than threshold C_{I}, A_{pb} is less than or equal to threshold A_{pb II} and greater than threshold A_{pbIII}, it can be determined that the bearing rolling element has a wear fault; if K is less than or equal to threshold K_{II}, C is less than or equal to threshold C_{I}, A_{pb} is less than or equal to threshold A_{pbII} it can be determined that the bearing rolling element has no fault.

In some embodiments, a current feature vector of the gearbox is determined according to amplitude ratios corresponding to different faults, the time domain kurtosis factor of the vibration acceleration signal, and the crest factor of the vibration acceleration signal; a fault type of the gearbox is determined according to the current feature vector and a plurality of sample feature vectors corresponding to a plurality of fault types.

For example, in order to quickly and accurately determine the fault type of the gearbox, a feature vector [K, C, A_{ga}, A_{gp}, A_{Bo}, A_{Bi}, A_{Bb}, Aₚₛ, Aₚₚ, Aₚᵣ, Aₚₒ, Aₚᵢ, A_{pb}] is formed by time domain kurtosis factor K and crest factor C calculated in step 110, and frequency amplitude rate A_{ga} of driving gear fault frequency component f_{ga}, frequency amplitude rate A_{gp} of driven gear fault frequency component f_{gp}, frequency amplitude rate A_{Bo} of bearing outer ring fault frequency component f_{Bo}, frequency amplitude rate A_{Bi} of bearing inner ring fault frequency component f_{Bi}, frequency amplitude rate A_{Bb} of bearing rolling element fault frequency component f_{Bb}, frequency amplitude rate Aₚₛ of sun gear fault frequency component fₛ, frequency amplitude rate Aₚₚ of planet gear fault frequency component fₚ, frequency amplitude rate Aₚᵣ of gear ring fault frequency component fᵣ, frequency amplitude rate Aₚₒ of bearing outer ring fault frequency component fₒ, frequency amplitude rate Aₚᵢ of bearing inner ring fault frequency component fᵢ, frequency amplitude rate A_{pb} of bearing rolling element fault frequency component f_{b} calculated in step 130.

Then, Grey Relation Analysis (GRA) is performed between the feature vector and standard mode feature vectors (sample feature vectors) representing driving gear faults and driven gear fault of a fixed shaft gear, bearing outer ring faults, bearing inner ring faults, bearing rolling element faults of a fixed shaft bearing, sun gear faults, planet gear faults and gear ring faults of a PGT, bearing outer ring faults, bearing inner ring faults and bearing rolling element faults of a planet gear bearing respectively, to obtain grey relations [ε_{ga}, ε_{gp}, ε_{Bo}, ε_{Bi}, ε_{Bb}, εₚₛ, εₚₚ, εₚᵣ, εₚₒ, εₚᵢ, ε_{pb}] between the feature vector of the test vibration acceleration signal and the standard mode feature vectors of the various element faults. For example, the standard mode feature vectors of the various element faults are regular parameters that are obtained based on statistics of a large number of experimental data.

In some embodiments, relation degrees between the current feature vector and a plurality of sample feature vectors are calculated, respectively; then, the relation degrees are sorted; a fault type of the gearbox is determined according to a result of the sorting.

For example, by sorting the grey relations in descending order, a fault type of the gearbox can be quickly and accurately determined. For example, the grey relations at the top N positions which are greater than a relation threshold can be determined as target grey relations; a fault type corresponding to the target grey relation is determined as a current fault type; alternatively, the grey relations at the top N positions can be determined as the target grey relations.

In the above embodiment, first of all, a noise elimination pre-process is performed on the measured vibration acceleration signal of the gearbox of construction machinery, and a time domain kurtosis factor K and a crest factor C are extracted; then, EMD/EEMD decomposition is performed on the de-noised signal to obtain independent IMF components representing a fixed shaft gear, a fixed shaft bearing, a PGT, and a planet gear bearing, respectively; next, FFT is performed on the various IMF components to extract a frequency amplitude rate of components comprised a gear fault frequency component in the spectrum of the fixed shaft gear, a frequency amplitude rate of components comprising a bearing element fault frequency component in the spectrum of the fixed shaft bearing, a frequency amplitude rate of components comprising a gear fault frequency component in the spectrum of the PGT, and a frequency amplitude rate of components comprising a bearing element fault frequency component in spectrum of the planet gear bearing; and a fault type of the gearbox is finally determined according to various thresholds.

For example, in order to quickly and accurately determine a fault type of the gearbox, a feature vector [K, C, A_{ga}, A_{gp}, A_{Bo}, A_{Bi}, A_{Bb}, Aₚₛ, Aₚₚ, Aₚᵣ, Aₚₒ, Aₚᵢ, A_{pb}] is formed by the time domain kurtosis factor K and crest factor C of the test signal, and the calculated frequency amplitude rates that characterize the various gear and bearing elements; then GRA is performed between the feature vector and standard mode feature vectors of various gear and bearing element faults to obtain grey relations [ε_{ga}, ε_{gp}, ε_{Bo}, ε_{Bi}, ε_{Bb}, εₚₛ, εₚₚ, εₚᵣ, εₚₒ, εₚᵢ, ε_{pb}]; and the grey relations are sorted in descending order, so as to quickly and accurately determine a fault type of the gearbox, thus effectively improving the accuracy of gearbox fault diagnosis.

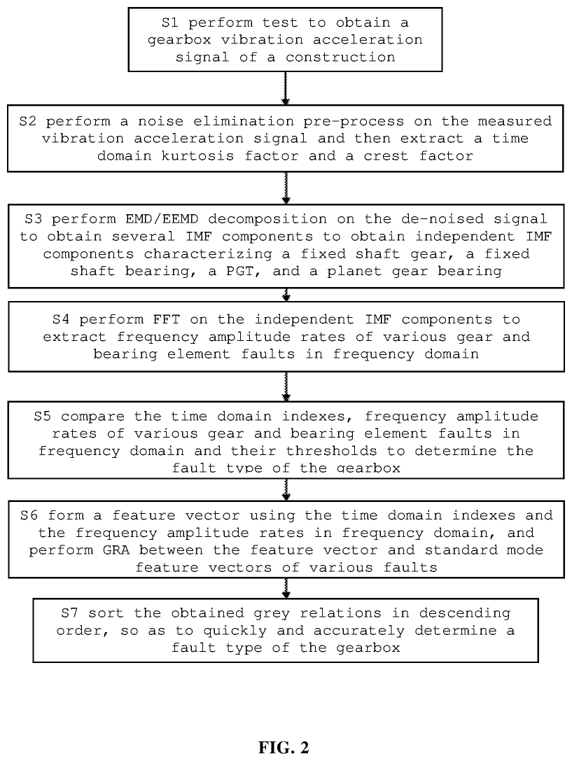

FIG. 2 shows the flow chart of the gearbox fault detection method according to other embodiments of the present disclosure.

As shown in FIG. 2, in step S1, according to some test standards, a vibration acceleration sensor can be disposed at a shell with large rigidity, for example, at the shell of its gearbox bearing seat of a construction machinery, to measure a gearbox vibration acceleration signal.

In step S2, a noise elimination pre-process is performed on the measured vibration acceleration signal of the gearbox of construction machinery, and then a time domain kurtosis factor K and a crest factor C are extracted.

In step S3, EMD/EEMD decomposition is performed on the de-noised signal to obtain several IMF components; false IMF components are removed according to relations between the IMF components and the signal before decomposition; and then independent IMF components representing a fixed shaft gear, a fixed shaft bearing, a PGT, and a planet gear bearing are selected respectively based on the numbers of relevant gear teeth, bearing parameters, input shaft speeds at specific gears, a natural frequency of the gearbox and the like.

In step S4, FFT is performed on the independent IMF components obtained in step S3 and representing a fixed shaft gear, a fixed shaft bearing, a PGT, and a planet gear bearing to extract a frequency amplitude rate of components comprised a gear fault frequency component in the spectrum of the fixed shaft gear, a frequency amplitude rate of components comprising a bearing element fault frequency component in the spectrum of the fixed shaft bearing, a frequency amplitude rate of components comprising a gear fault frequency component in the spectrum of the PGT, and a frequency amplitude rate of components comprising a bearing element fault frequency component in spectrum of the planet gear bearing, to prepare for determining a fault type of the gearbox.

In step S5, the time domain kurtosis factor K and crest factor C calculated in step S2, the frequency amplitude rate of components contained a gear fault frequency component in the spectrum of the fixed shaft gear, the frequency amplitude rate of components comprising a bearing element fault frequency component in the spectrum of the fixed shaft bearing, the frequency amplitude rate of components comprising a gear fault frequency component in the spectrum of the PGT, and the frequency amplitude rate of components comprising a bearing element fault frequency component in spectrum of the planet gear bearing calculated in the frequency domain in step S4 are compared with their respective thresholds to determine the fault type of the gearbox.

In step S6, in order to quickly and accurately determine the fault type of the gearbox, a feature vector [K, C, A_{ga}, A_{gp}, A_{Bo}, A_{Bi}, A_{Bb}, Aₚₛ, Aₚₚ, Aₚᵣ, Aₚₒ, Aₚᵢ, A_{pb}] is formed by time domain kurtosis factor K and crest factor C calculated in step S2, and frequency amplitude rate A_{ga} of driving gear fault frequency component f_{ga}, frequency amplitude rate A_{gp} of driven gear fault frequency component f_{gp}, frequency amplitude rate A_{Bo} of bearing outer ring fault frequency component f_{Bo}, frequency amplitude rate A_{Bi} of bearing inner ring fault frequency component f_{Bi}, frequency amplitude rate A_{Bb} of bearing rolling element fault frequency component f_{Bb}, frequency amplitude rate Aₚₛ of sun gear fault frequency component fₛ, frequency amplitude rate Aₚₚ of planet gear fault frequency component fₚ, frequency amplitude rate Aₚᵣ of gear ring fault frequency component fᵣ, frequency amplitude rate Aₚₒ of bearing outer ring fault frequency component fₒ, frequency amplitude rate Aₚᵢ of bearing inner ring fault frequency component fᵢ, frequency amplitude rate A_{pb} of bearing rolling element fault frequency component f_{b} calculated in step S4.

Then, GRA is performed between the feature vector and standard mode feature vectors representing driving gear faults and driven gear fault of a fixed shaft gear, bearing outer ring faults, bearing inner ring faults, bearing rolling element faults of a fixed shaft bearing, sun gear faults, planet gear faults and gear ring faults of a PGT, bearing outer ring faults, bearing inner ring faults and bearing rolling element faults of a planet gear bearing respectively, to obtain grey relations [ε_{ga}, ε_{gp}, ε_{Bo}, ε_{Bi}, ε_{Bb}, εₚₛ, εₚₚ, εₚᵣ, εₚₒ, εₚᵢ, ε_{pb}] between the feature vector of the test vibration acceleration signal and the standard mode feature vectors of the various element faults. The standard mode feature vectors of the various element faults are regular parameters that are obtained based on statistics of a large number of experimental data.

In step S7, the grey relations obtained in step S6 are sorted in descending order, so that a fault type of the gearbox can be quickly and accurately determined.

One of the embodiments in step S5 or the embodiments in steps S6 and S7 may be selected to be executed, or both of the two kinds of embodiments are executed according to the actual situation. There is no order of execution for these two kinds of embodiments.

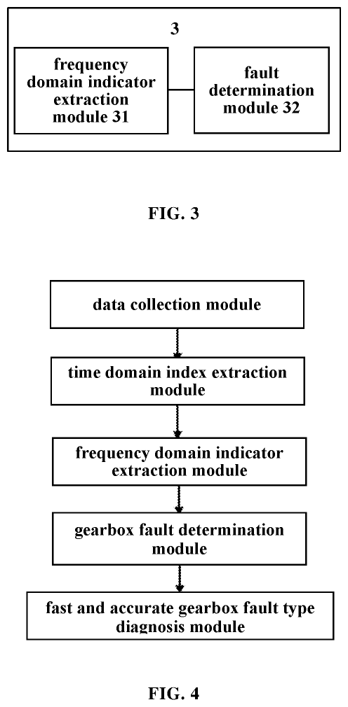

FIG. 3 shows a block diagram of a gearbox fault detection device according to some embodiments of the present disclosure.

As shown in FIG. 3, the gearbox fault detection device 3 comprises: a frequency domain indicator extraction module 31 for acquiring plurality of IMF components of a vibration acceleration signal of a gearbox, different IMF components corresponding to different parts of the gearbox; from spectrum of the plurality of IMF components, extracting frequency components corresponding to faults of different parts as fault frequencies, and frequency components corresponding to the different parts as relevant frequencies; a fault determination module 32 for determining a fault type of the gearbox according to the fault frequencies and the relevant frequencies.

In some embodiments, the fault determination module 32 is used for determining a fault type of the gearbox according to combined harmonic frequencies of the fault frequencies and the relevant frequencies, wherein a combined harmonic frequency is determined according to a harmonic frequency of a fault frequency and a harmonic frequency of a relevant frequency.

In some embodiments, the fault determination module 32 is used for determining a fault type of the gearbox according to an amplitude ratio of a sum of amplitude values of a combined harmonic frequency to a sum of amplitude values of a relevant frequency.

In some embodiments, the different parts comprise a fixed shaft gear; the relevant frequency corresponding to the fixed shaft gear comprises a gear mesh frequency; the fault of the fixed shaft gear comprises at least one of a fixed shaft driving gear fault or a fixed shaft driven gear fault, the fault frequency corresponding to the fixed shaft driving gear fault comprises a driving gear fault frequency, and the fault frequency corresponding to the fixed shaft driven gear fault comprises a driven gear fault frequency.

In some embodiments, in a case that the greatest common divisor (GCD) between the numbers of teeth of a pair of fixed shaft gears that mesh with each other is not 1, for the fixed shaft driven gear fault, the relevant frequency corresponding to the fixed shaft gear further comprises a gear assembly phase frequency.

In some embodiments, the different parts comprise a fixed shaft bearing; the relevant frequency corresponding to the fixed shaft bearing comprises a gearbox natural frequency; the fault of the fixed shaft bearing comprises at least one of a fixed shaft bearing outer ring fault, a fixed shaft bearing inner ring fault or a fixed shaft bearing rolling element fault; the fault frequency corresponding to the fixed shaft bearing outer ring fault comprises a bearing outer ring fault frequency, the fault frequency corresponding to the fixed shaft bearing inner ring fault frequency comprises a fixed shaft bearing inner ring fault frequency, and the fault frequency corresponding to the fixed shaft bearing rolling element fault comprises a bearing rolling element fault frequency.

In some embodiments, the different parts comprise a planetary gear train (PGT); the relevant frequency corresponding to the PGT comprises a gear mesh frequency; the fault of the PGT comprises at least one of a sun gear fault, a planet gear fault or a gear ring fault; for the sun gear fault, the relevant frequency corresponding to the PGT further comprises an absolute rotation frequency of the sun gear, and the fault frequency corresponding to the PGT comprises a fault frequency of the sun gear; for the planet gear fault, the relevant frequency corresponding to the PGT further comprises a planet carrier rotation frequency, and the fault frequency corresponding to the PGT comprises a planet gear fault frequency; for the gear ring fault, the fault frequency corresponding to the PGT comprises a gear ring fault frequency.

In some embodiments, the different parts comprise a planet gear bearing; the relevant frequency corresponding to the planet gear bearing comprises a gearbox natural frequency and a planet carrier rotation frequency; the fault of the planet gear bearing comprises at least one of a planet gear bearing outer ring fault, a planet gear bearing inner ring fault, or a planet gear bearing rolling element fault; for the planet gear bearing outer ring fault, the relevant frequency corresponding to the planet gear bearing further comprises a bearing outer ring rotation frequency, and the fault frequency corresponding to the planet gear bearing comprises a bearing outer ring fault frequency; for the planet gear bearing inner ring fault, the fault frequency corresponding to the planet gear bearing comprises a bearing inner ring fault frequency; for the planet gear bearing rolling element fault, the relevant frequency corresponding to the planet gear bearing further comprises a bearing cage rotation frequency, and the fault frequency corresponding to the planet gear bearing comprises a bearing rolling element fault frequency.

In some embodiments, the fault determination module 32 is used for determining a fault type of the gearbox according to comparisons of amplitude ratios corresponding to different faults and ratio thresholds, wherein different amplitude ratios correspond to different ratio thresholds.

In some embodiments, the fault determination module 32 is used for determining a current feature vector of the gearbox according to the amplitude ratios corresponding to different faults, a time domain kurtosis factor of the vibration acceleration signal, and a crest factor of the vibration acceleration signal; determining a fault type of the gearbox according to the current feature vector and a plurality of sample feature vectors corresponding to a plurality of fault types.

In some embodiments, the fault determination module 32 is used for calculating a relation degree of the current feature vector and each of the plurality of sample feature vectors, respectively; sorting the relation degrees; determining the fault type of the gearbox according to a result of the sorting.

In some embodiments, the frequency domain indicator extraction module 31 is used for performing EMD or EEMD on the vibration acceleration signal to obtain the plurality of IMF components.

In some embodiments, the frequency domain indicator extraction module 31 is used for performing EMD or EEMD on the vibration acceleration signal to obtain plurality of candidate IMF components; according to relevant parameters of different parts of the gearbox, determining the plurality of IMF components from the plurality of candidate IMF components.

In some embodiments, the frequency domain indicator extraction module 31 is used for removing a false IMF component from the plurality of candidate IMF components according to relations between the plurality of candidate IMF components and the vibration acceleration signal; determining the plurality of IMF components from the plurality of candidate IMF components after removing the false IMF component.

FIG. 4 shows a block diagram of the gearbox fault detection device according to other embodiments of the present disclosure.

As shown in FIG. 4, according to some test standards, as a data collection module, a vibration acceleration sensor is disposed at a shell with large rigidity, for example, at the shell of the gearbox bearing seat of a construction machinery, to measure a gearbox vibration acceleration signal.

A time domain index extraction module performs a noise elimination pre-process on the measured vibration acceleration signal of the gearbox, and then extracts a time domain kurtosis factor K and a crest factor C.

A frequency domain indicator extraction module performs EMD/EEMD decomposition on the de-noised signal to obtain several IMF components, removes false IMF components according to their relations with the signal before decomposition, and then selects independent IMF components characterizing a fixed shaft gear, a fixed shaft bearing, a PGT, and a planet gear bearing respectively based on the numbers of relevant gear teeth, bearing parameters, input shaft speeds at specific gears, a natural frequency of the gearbox and the like; next, it performs FFT on the various IMF components to extract a frequency amplitude rate of components contained a gear fault frequency component in the spectrum of the fixed shaft gear, a frequency amplitude rate of components comprising a bearing element fault frequency component in the spectrum of the fixed shaft bearing, a frequency amplitude rate of components comprising a gear fault frequency component in the spectrum of the PGT, and a frequency amplitude rate of components comprising a bearing element fault frequency component in spectrum of the planet gear bearing.

A gearbox fault determination module for comparing the extracted time domain kurtosis factor K and crest factor C, the frequency amplitude rate of components contained a gear fault frequency component in the spectrum of the fixed shaft gear, the frequency amplitude rate of components comprising a bearing element fault frequency component in the spectrum of the fixed shaft bearing, the frequency amplitude rate of components comprising a gear fault frequency component in the spectrum of the PGT, and the frequency amplitude rate of components comprising a bearing element fault frequency component in spectrum of the planet gear bearing calculated in the frequency domain with their respective thresholds to determine the fault type of the gearbox.

In order to quickly and accurately determine the fault type of the gearbox, a fast and accurate gearbox fault type diagnosis module forms a feature vector [K, C, A_{ga}, A_{gp}, A_{Bo}, A_{Bi}, A_{Bb}, Aₚₛ, Aₚₚ, Aₚᵣ, Aₚₒ, Aₚᵢ, A_{pb}] using the extracted time domain kurtosis factor K and crest factor C, and the calculated frequency amplitude rate A_{ga} of driving gear fault frequency component f_{ga}, frequency amplitude rate A_{gp} of driven gear fault frequency component f_{gp}, frequency amplitude rate AB, of bearing outer ring fault frequency component f_{Bo}, frequency amplitude rate A_{Bi} of bearing inner ring fault frequency component f_{Bi}, frequency amplitude rate A_{Bb} of bearing rolling element fault frequency component f_{Bb}, frequency amplitude rate Aₚₛ of sun gear fault frequency component fₛ, frequency amplitude rate Aₚₚ of planet gear fault frequency component fₚ, frequency amplitude rate Aₚᵣ of gear ring fault frequency component fᵣ, frequency amplitude rate Aₚₒ of bearing outer ring fault frequency component fₒ, frequency amplitude rate Aₚᵢ of bearing inner ring fault frequency component fᵢ, frequency amplitude rate A_{pb} of bearing rolling element fault frequency component f_{b}; and then performs GRA between the feature vector and standard mode feature vectors characterizing driving gear faults and driven gear fault of a fixed shaft gear, bearing outer ring faults, bearing inner ring faults, bearing rolling element faults of a fixed shaft bearing, sun gear faults, planet gear faults and gear ring faults of a PGT, bearing outer ring faults, bearing inner ring faults and bearing rolling element faults of a planet gear bearing respectively, to obtain grey relations [ε_{ga}, ε_{gp}, ε_{Bo}, ε_{Bi}, ε_{Bb}, εₚₛ, εₚₚ, εₚᵣ, εₚₒ, εₚᵢ, ε_{pb}] between the feature vector of the test vibration acceleration signal and the standard mode feature vectors of the various element faults; finally it sorts the obtained grey relations in descending order, so as to quickly and accurately determine a fault type of the gearbox.

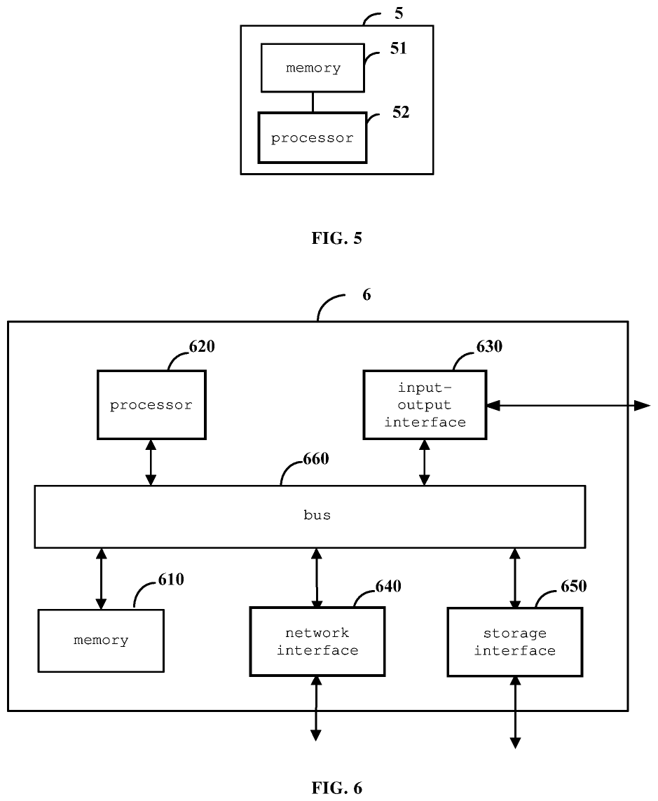

FIG. 5 shows a block diagram of the gearbox fault detection device according to still other embodiments of the present disclosure.

As shown in FIG. 5, the gearbox fault detection device 5 of this embodiment comprises: a memory 51 and a processor 52 coupled to the memory 51, the processor 52 configured to, based on instructions stored in the memory 51, carry out the gearbox fault detection method according to any one of the embodiments of the present disclosure.

Wherein, the memory 51 may comprise, for example, system memory, a fixed non-transitory storage medium, or the like. The system memory stores, for example, an operating system, applications, a boot loader, a database, and other programs.

FIG. 6 shows a block diagram of a gearbox fault detection device according to further embodiments of the present disclosure.

As shown in FIG. 6, the gearbox fault detection device 6 of this embodiment comprises: a memory 610 and a processor 620 coupled to the memory 610, the processor 620 configured to, based on instructions stored in the memory 610, carry out the gearbox fault detection method according to any one of the embodiments of the present disclosure.

The memory 610 may comprise, for example, system memory, a fixed non-transitory storage medium, or the like. The system memory stores, for example, an operating system, application programs, a boot loader, and other programs.

The gearbox fault detection device 6 may further comprise an input-output interface 630, a network interface 640, a storage interface 650, and the like. These interfaces 630, 640, 650 and the memory 610 and the processor 620 may be connected to each other through a bus 660, for example. Wherein, the input-output interface 630 provides a connection interface for input-output devices such as a display, a mouse, a keyboard, a touch screen, a microphone, a loudspeaker, etc. The network interface 640 provides a connection interface for various networked devices. The storage interface 650 provides a connection interface for external storage devices such as an SD card and a USB flash disk.

Those skilled in the art should understand that the embodiments of the present disclosure may be provided as a method, a system, or a computer program product. Therefore, embodiments of the present disclosure can take the form of an entirely hardware embodiment, an entirely software embodiment or an embodiment comprising both hardware and software elements. Moreover, the present disclosure may take the form of a computer program product embodied on one or more computer-usable non-transitory storage media (comprising but not limited to disk storage, CD-ROM, optical storage device, etc.) having computer-usable program code embodied therein.

Heretofore, the gearbox fault detection method, the gearbox fault detection device, and the non-transitory computer-readable storage medium according to the present disclosure have been described in detail. In order to avoid obscuring the concepts of the present disclosure, some details known in the art are not described. Based on the above description, those skilled in the art can understand how to implement the technical solutions disclosed herein.

The method and system of the present disclosure may be implemented in many ways. For example, the method and system of the present disclosure may be implemented by software, hardware, firmware, or any combination of software, hardware, and firmware. The above sequence of steps of the method is merely for the purpose of illustration, and the steps of the method of the present disclosure are not limited to the above-described specific order unless otherwise specified. In addition, in some embodiments, the present disclosure may also be implemented as programs recorded in a recording medium, which comprise machine-readable instructions for implementing the method according to the present disclosure. Thus, the present disclosure also covers a recording medium storing programs for executing the method according to the present disclosure.

Although some specific embodiments of the present disclosure have been described in detail by way of example, those skilled in the art should understand that the above examples are only for the purpose of illustration and are not intended to limit the scope of the present disclosure. It should be understood by those skilled in the art that the above embodiments may be modified without departing from the scope and spirit of the present disclosure. The scope of the disclosure is defined by the following claims.

1. A gearbox fault detection method, comprising:
acquiring a plurality of Intrinsic Mode Function (IMF) components of a vibration acceleration signal of a gearbox, different IMF components corresponding to different parts of the gearbox;
from spectrum of the plurality of IMF components, extracting frequency components corresponding to faults of the different parts as fault frequencies, and frequency components corresponding to the different parts as relevant frequencies; and
determining a fault type of the gearbox according to the fault frequencies and the relevant frequencies.

2. The detection method according to claim 1, wherein the determining a fault type of the gearbox comprises:
determining the fault type of the gearbox according to a combined harmonic frequency of the fault frequencies and the relevant frequencies, wherein the combined harmonic frequency is determined according to a harmonic frequency of a fault frequency and a harmonic frequency of a relevant frequency.

3. The detection method according to claim 2, wherein the determining the fault type of the gearbox comprises:
determining the fault type of the gearbox according to an amplitude ratio of a sum of amplitude values of the combined harmonic frequency to a sum of amplitude values of a relevant frequency.

4. The detection method according to claim 3, wherein:
the different parts comprise a fixed shaft gear;
a relevant frequency corresponding to the fixed shaft gear comprises a gear mesh frequency; and
a fault of the fixed shaft gear comprises at least one of a fixed shaft driving gear fault or a fixed shaft driven gear fault, a fault frequency corresponding to the fixed shaft driving gear fault comprises a driving gear fault frequency, and a fault frequency corresponding to the fixed shaft driven gear fault comprises a driven gear fault frequency.

5. The detection method according to claim 4, wherein in a case that a greatest common divisor (GCD) between numbers of teeth of a pair of fixed shaft gears that mesh with each other is not 1, for the fixed shaft driven gear fault, the relevant frequency corresponding to the fixed shaft gear further comprises a gear assembly phase frequency.

6. The detection method according to claim 3, wherein:
the different parts comprise a fixed shaft bearing;
a relevant frequency corresponding to the fixed shaft bearing comprises a gearbox natural frequency;
a fault of the fixed shaft bearing comprises at least one of a fixed shaft bearing outer ring fault, a fixed shaft bearing inner ring fault or a fixed shaft bearing rolling element fault; and
a fault frequency corresponding to the fixed shaft bearing outer ring fault comprises a bearing outer ring fault frequency, a fault frequency corresponding to the fixed shaft bearing inner ring fault frequency comprises a fixed shaft bearing inner ring fault frequency, and a fault frequency corresponding to the fixed shaft bearing rolling element fault comprises a bearing rolling element fault frequency.

7. The detection method according to claim 3, wherein:
the different parts comprise a planetary gear train (PGT);
a relevant frequency corresponding to the PGT comprises a gear mesh frequency;
a fault of the PGT comprises at least one of a sun gear fault, a planet gear fault or a gear ring fault;
for the sun gear fault, the relevant frequency corresponding to the PGT further comprises an absolute rotation frequency of the sun gear, and a fault frequency corresponding to the PGT comprises a fault frequency of the sun gear;
for the planet gear fault, the relevant frequency corresponding to the PGT further comprises a planet carrier rotation frequency, and the fault frequency corresponding to the PGT comprises a planet gear fault frequency; and
for the gear ring fault, the fault frequency corresponding to the PGT comprises a gear ring fault frequency.

8. The detection method according to claim 3, wherein:
the different parts comprise a planet gear bearing;
a relevant frequency corresponding to the planet gear bearing comprises a gearbox natural frequency and a planet carrier rotation frequency;
a fault of the planet gear bearing comprises at least one of a planet gear bearing outer ring fault, a planet gear bearing inner ring fault, or a planet gear bearing rolling element fault;
for the planet gear bearing outer ring fault, the relevant frequency corresponding to the planet gear bearing further comprises a bearing outer ring rotation frequency, and a fault frequency corresponding to the planet gear bearing comprises a bearing outer ring fault frequency;
for the planet gear bearing inner ring fault, the fault frequency corresponding to the planet gear bearing comprises a bearing inner ring fault frequency; and
for the planet gear bearing rolling element fault, the relevant frequency corresponding to the planet gear bearing further comprises a bearing cage rotation frequency, and the fault frequency corresponding to the planet gear bearing comprises a bearing rolling element fault frequency.

9. The detection method according to claim 3, wherein the determining a fault type of the gearbox comprises:
determining a fault type of the gearbox according to comparisons of amplitude ratios corresponding to different faults and ratio thresholds, wherein different amplitude ratios correspond to different ratio thresholds.

10. The detection method according to claim 3, wherein the determining a fault type of the gearbox comprises:
determining a current feature vector of the gearbox according to the amplitude ratios corresponding to different faults, a time domain kurtosis factor of the vibration acceleration signal, and a crest factor of the vibration acceleration signal; and
determining the fault type of the gearbox according to the current feature vector and a plurality of sample feature vectors corresponding to a plurality of fault types.

11. The detection method according to claim 10, wherein the determining a fault type of the gearbox comprises:
calculating a relation degree of the current feature vector and each of the plurality of sample feature vectors respectively;
sorting relation degrees; and
determining the fault type of the gearbox according to a result of a result of the sorting.

12. The detection method according to claim 1, wherein the acquiring the plurality of IMF components of the vibration acceleration signal of the gearbox comprises:
performing Empirical Mode Decomposition (EMD) or Ensemble Empirical Mode Decomposition (EEMD) on the vibration acceleration signal to obtain the plurality of IMF components.

13. The detection method according to claim 12, wherein the acquiring the plurality of IMF components comprises:
performing EMD or EEMD on the vibration acceleration signal to obtain a plurality of candidate IMF components; and
determining the plurality of IMF components from the plurality of candidate IMF components, according to relevant parameters of the different parts of the gearbox.

14. The detection method according to claim 13, wherein the acquiring the plurality of IMF components comprises:
removing a false IMF component from the plurality of candidate IMF components according to relations between the plurality of candidate IMF components and the vibration acceleration signal; and
determining the plurality of IMF components from the plurality of candidate IMF components after removing the false IMF component.

15. (canceled)

16. A gearbox fault detection device, comprising:
memory; and
a processor coupled to the memory, the processor configured to, based on instructions stored in the memory, carry out a gearbox fault detection method comprising:
acquiring a plurality of Intrinsic Mode Function (IMF) components of a vibration acceleration signal of a gearbox, different IMF components of the plurality of IMF components corresponding to different parts of the gearbox;
from a spectrum of the plurality of IMF components, extracting frequency components corresponding to faults of the different parts as fault frequencies and frequency components corresponding to the different parts as relevant frequencies; and
determining a fault type of the gearbox according to the fault frequencies and the relevant frequencies.

17. A non-transitory computer-readable storage medium on which a computer program is stored, which when executed by a processor implements a gearbox fault detection method comprising:
acquiring a plurality of Intrinsic Mode Function (IMF) components of a vibration acceleration signal of a gearbox, different IMF components of the plurality of IMF components corresponding to different parts of the gearbox;
from a spectrum of the plurality of IMF components, extracting frequency components corresponding to faults of the different parts as fault frequencies and frequency components corresponding to the different parts as relevant frequencies; and
determining a fault type of the gearbox according to the fault frequencies and the relevant frequencies.
